(19) United States
(12) Patent Application Publication
(10) Pub. No.: US 2005/0251776 A1
(43) Pub. Date: Nov. 10, 2005

(54) INTEGRATED CIRCUIT DESIGN SYSTEM

(76) Inventors: Chien-Jung Hsin, Hsin-Chu (TW); Jun-Jyeh Hsiao, Hsin-Chu (TW); Sheng-Chun Lee, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/710,905

(22) Filed: Aug. 12, 2004

(30) Foreign Application Priority Data
May 7, 2004 (TW) 093112925

(51) Int. Cl. G06F 17/50

(52) U.S. Cl. 716/11; 716/6

(57) ABSTRACT

An integrated circuit design system has a second interface for displaying a plurality of description instructions corresponding to a specific integrated circuit according to a variety of display instructions, a first interface for inputting the display instructions and for updating a description instruction displayed on the second interface according to a display instruction input to the second interface, and a logic unit for updating remaining description instructions of the plurality of description instructions according to an updated description instruction updated by the first interface.

### BACKGROUND OF INVENTION

1. Field of the Invention

The present invention relates to an integrated circuit, and more particularly, to an integrated circuit design system for designing an application-specific integrated circuit (ASIC).

2. Description of the Prior Art

In accordance with the rapid development of electronic technologies, many complicated circuits can be integrated into an integrated circuit (IC) to save space in an electronic apparatus having complicated design. Integrated circuit design systems are used to design ICs.

Please refer to FIG. 1, which is a flow chart of a method 100 demonstrating how an integrated circuit design system designs an application-specific integrated circuit (ASIC) according to the prior art. The method 100 comprises the following steps:
Step 102: Start;
Step 104: Logic design & synthesis;
(Logic designers input hardware description language (HDL) to the integrated circuit design system to form a first netlist, and transfer the first netlist and timing constraints corresponding to the ASIC to physical designers.)
Step 106: Placement & routing; (The physical designers execute a variety of processes, such as a placement & routing process, a clock tree synthesis process, a timing optimization process, and a cell and wire delay extraction process, on an IC chip according to the first netlist and the timing constraints transferred from the logic designers to update the first netlist to a second netlist; and transfer the second netlist and corresponding cell and wire delay information in standard delay format (SDF) back to the logic designers.)
Step 108: Timing analysis & functional verification, if successful, go to step 190, else go to step 110; (The logic designers check the SDF and the second netlist to determine if the second netlist violates the timing constraints or any function that the ASIC should have.)
Step 110: Netlist update; and
(The method 100 coming thus far indicates that the second netlist transferred by the physical designers still has some errors existing in either the timing constraints or the function, so the logic designers therefore have to correct the errors by updating the second netlist and transfer the updated second netlist to the physical designers. The physical designers must execute a corresponding engineering change order (ECO) again.)
Step 190: End.

According to the scenario described above, a netlist such as an Nₜₕ netlist shown in FIG. 1 has to be transferred back and forth between the logic designers and the physical designers until all the errors of the Nₜₕ netlist have been corrected.

### SUMMARY OF INVENTION

It is therefore a primary objective of the claimed invention to provide an integrated circuit design system to solve the drawbacks of the prior art.

According to the claimed invention, the integrated circuit design system includes a second interface for displaying a plurality of description instructions corresponding to an application-specific integrated circuit (ASIC) according to a variety of display instructions, a first interface for inputting the display instructions and for updating the description instructions displayed on the second interface according to the display instructions, and a logic unit for updating any description instruction but an updated description updated by the first interface corresponding to the ASIC according to the updated description instruction.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flow chart of a method demonstrating how an integrated circuit design system designs an ASIC according to the prior art.

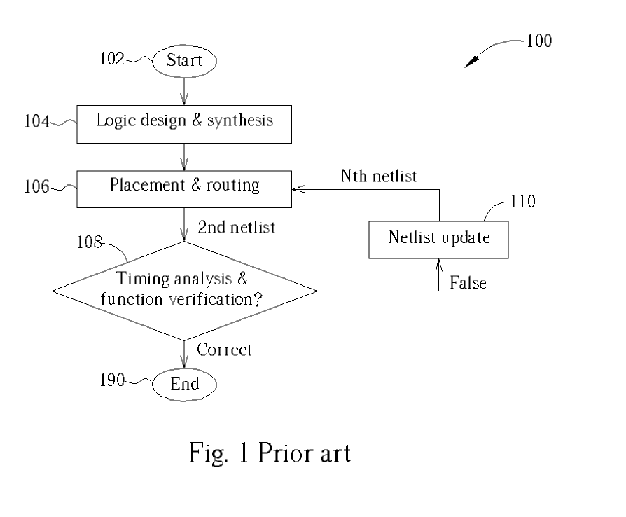

FIG. 2 is a schematic diagram of an IC chip of the preferred embodiment according to the present invention.

FIG. 3 is a schematic diagram of an ASIC of the IC chip shown in FIG. 2 according to the present invention.

FIG. 4 is a schematic diagram of an integrated circuit design system of the preferred embodiment according to the present invention.

FIG. 5 is an enlarged view of a plurality of elementary cells encircled within a dotted line shown in FIG. 3 on a physical circuit window shown in FIG. 4.

### DETAILED DESCRIPTION

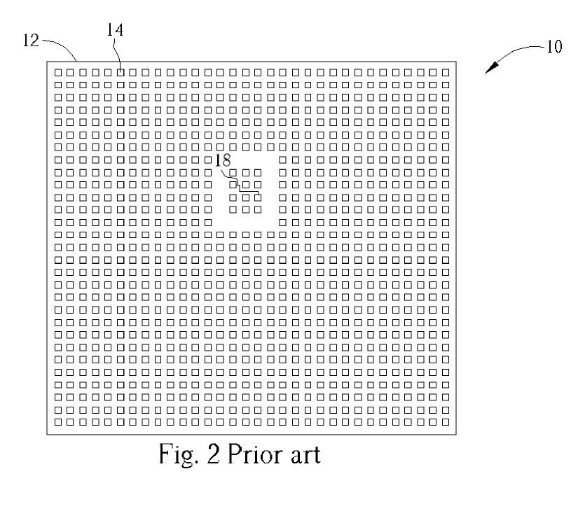

Please refer to FIG. 2, which is a schematic diagram of an integrated circuit chip 10 of the preferred embodiment according to the present invention. The integrated circuit chip 10 comprises a semiconductor substrate 12, a plurality of elementary cells 14 installed on the semiconductor substrate 12, and a plurality of interconnects 18 for connecting the elementary cells 14.

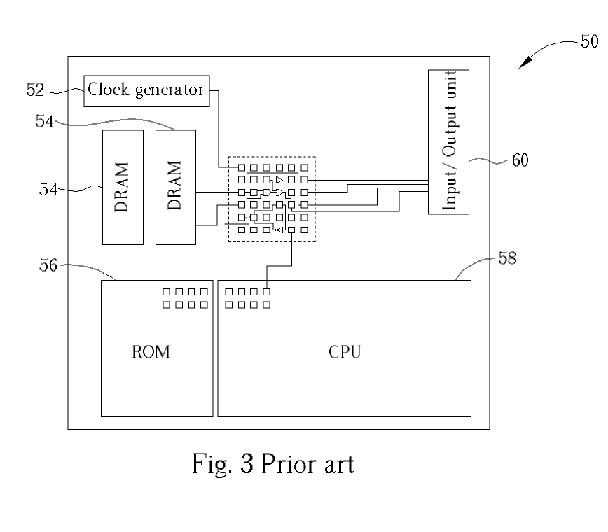

In general, in a process of designing an ASIC 50, a plurality of the elementary cells 14 installed neighboring to one another can be arranged to form a macro cell having a specific function. Please refer to FIG. 3, which is a schematic diagram of the ASIC 50 of the integrated circuit chip 10 shown in FIG. 2. The ASIC 50 comprises a plurality of elementary cells 14, a plurality of interconnects 18, a clock generator 52, two DRAMs 54, a read-only memory (ROM) 56, a CPU 58, an input/output unit 60, and a plurality of macro cells, each of which is composed of a plurality of elementary cells 14.

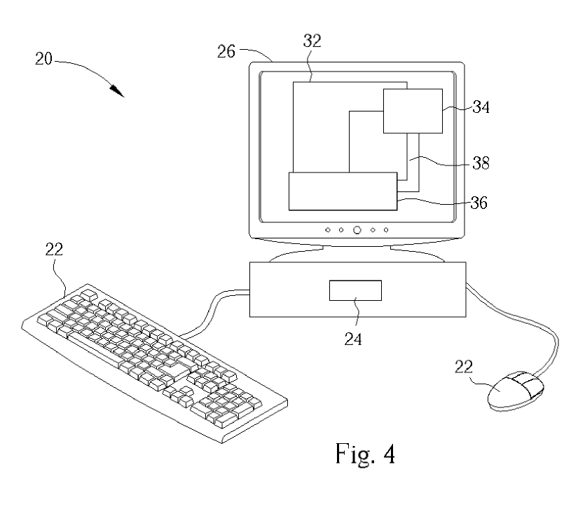

Please refer to FIG. 4, which is a schematic diagram of an integrated circuit design system 20 of the preferred embodiment according to the present invention. The system 20 comprises a first interface 22, a second interface 26, and a logic unit 24 electrically connected between the first and second interfaces 22 and 26.

The first interface 22 is installed for a user to input display instructions and to update information related to ASIC 50 of a variety of reports, such as a netlist, a noise analysis report, a power analysis report, and a timing slack report, etc.

The logic unit 24 is installed to execute a variety of processes, such as a placement & routing process, a clock tree synthesis process, a timing optimization process, and a cell and wire delay extraction process, etc., on the integrated circuit chip 10 according to the information updated through the first interface 22 by the user, and to further generate an updated netlist, an updated noise analysis report, an updated power analysis, an updated timing slack report, and an updated cell and wire delay extraction report.

In operation, for example, if a netlist of the ASIC 50 has been updated by a logic designer with the use of the first interface 22, then the logic unit 24 will execute the placement & routing process, the clock tree synthesis process, the timing optimization process, and the cell and wire delay extraction in accordance with the updated netlist, and generate a variety of information relating to the ASIC 50, such as the updated noise analysis report, the updated power analysis, the updated timing slack report, and the updated cell and wire delay extraction report, according to the updated netlist. In another example, if what the logic designer has updated through the use of the first interface 22 is circuit component information of the timing slack report of the ASIC 50, the logic unit 24 will generate another updated noise analysis report, another updated power analysis, another updated netlist, and another updated cell and wire delay extraction according to the updated circuit component information of the timing slack report, and all of the updated noise analysis report, the updated power analysis, the updated netlist, and the updated cell and wire delay extraction relating to the updated circuit component information of the timing slack report. Equivalently, the integrated circuit design system 20 transforms the ASIC 50 into a core database consisting of the above-mentioned information, any updated information of the core database providing an influence on the remaining information.

In the core database, the timing slack report comprises a plurality of timing slack information, each of which comprises a plurality of timing slacks Sₛs, each of the timing slacks Sₛs equal to a required time Rₛ, within which a signal S has to be stabilized, minus an arrival time Aₛ, the time for the signal S to be stabilized. If the timing slack Sₛ is positive, the signal S has been stabilized before arriving at other circuits, such as a latch capable of fetching the signal S during a rising edge of a driving clock, when the signal S has been stabilized. On the contrary, if the timing slack Sₛ is negative, the signal S is not stabilized during the rising edge of the driving clock and the latch has therefore a large chance of fetching a wrong signal S. The benefit of the logic unit 24 calculating the timing slack information is that the logic designer can update the netlist with the use of the first interface 22 in accordance with the timing slack information, and instantly acquire new timing slack information, which are calculated by the logic unit 24 and corresponding to the updated netlist, so as to promote the efficiency in designing the ASIC 50 and to reduce any potential errors that the ASIC 50 may have.

The second interface 26 is installed to display the varieties of information of the core database in accordance with the display instructions. These varieties of information comprise, for example, a netlist, an updated netlist, and a plurality of the netlist- or the updated netlist-related reports, such as a placement & routing report, a clock tree synthesis report, a timing optimization report, and a cell and wire delay extraction report, etc.

In the preferred embodiment, the second interface 26 only has to display the negative timing slacks Sₛs of the timing slack information calculated by the logic unit 24, instead of displaying all of the timing slack Sₛs, which consist of not only the negative timing slacks Sₛs, but also the positive timing slacks Sₛs, which correspond to signals which are not stable and have a large chance of induced errors, so as to reduce the complexity of the integrated circuit design system 20.

In the preferred embodiment, the first interface 22 can be a keyboard 22 or a mouse 22, and the second interface 26 can be a display panel 26, on which the above-mentioned information, such as the netlist and the timing slack report, can be displayed in the form of a window. Shown in FIG. 4 are a noise analysis report window 32 for illustrating the noise analysis report corresponding to the ASIC 50, a netlist window 34 for illustrating the netlist corresponding to the ASIC 50, a physical circuit window 36 for illustrating the placement & routing of the integrated circuit chip 10 corresponding to the netlist, and a timing slack report window 38 for illustrating the timing slack report corresponding to the netlist generated by the logic unit 24, the timing slack report shown on the timing slack window 38 comprising the negative timing slacks Sₛs only.

According to the prior art described previously, after updating a netlist according to timing slack information transferred from the physical designers, the logic designers are not able to refer to any physical circuit information corresponding to the timing slack information and cannot know immediately whether the timing slack problem corresponding to a physical circuit corresponding to the updated netlist is solved or not, so the logic designers and the physical designers still have to alternatively update the netlist in accordance with the timing slack information, update the physical circuit in accordance with the updated netlist, and calculate the timing slack information corresponding to the updated physical circuit.

However, according to the preferred embodiment of the present invention, the first interface 22 is capable of updating any information of the core database, which is in equivalent corresponding to the ASIC 50, the logic unit 24 is capable of updating the remaining information of the core database according to the updated information, and the display panel 26 is capable of displaying the noise analysis report on the noise analysis report window 32, the netlist on the netlist window 34, the layout of the ASIC 50 on the physical circuit window 36, and the timing slack report corresponding to the netlist of the ASIC 50 on the timing slack report window 38 in accordance with the display instructions input to the keyboard 22 or the mouse 22. The logic designers therefore are able to update the circuit component information shown on any one of the windows 32, 34, 36 and 38, without the need to ask for the help offered by the physical designers.

Please refer to Table 1, which contains a timing slack information TS shown in the timing slack window 38.

TABLE 1

| | Incr | Path |
|---|---|---|
| clock SYSCK266 | 0 | 0 |
| CGEN_A_PST/PST_ff_0/CK | 0 | 0 |
| CGEN_A_PST/PST_ff_0/Q | 0.54 | 0.54 |
| CGEN_A_PST/I_62/Y (NAND2x1) | 0.18 | 0.72 |
| CGEN_A_PST/I_23/Y (BUFx4) | 0.07 | 0.79 |
| CGEN_A_PST/I_42/Y (BUFx8) | 0.06 | 0.85 |
| CGEN_A_PST/I_12/Y (AND2x1) | 0.15 | 1.0 |
| CGEN_A_PST/PST_ff_1/D (SDFFRX1) | 0 | |
| data arrival time | | 1.0 |
| clock SYSCLK266 | 5 | 5 |
| CGEN_A_PST/PST_ff_1/CK | 0 | 5 |
| library setup time | −0.12 | 4.88 |
| data required time | | 4.88 |
| slack (TS) | | 3.88 |

The timing slack TS is equal to a required time Rs minus an arrival time As, which is the sum of delay time of a plurality of components disposed along a data path. In Table 1, the arrival time As is equal to 0.54+0.18+0.07+0.06+0.15=1.0, and the timing slack TS is equal to 4.88−1.0=3.8. After a logic designer updates the netlist corresponding to the ASIC 50, the logic unit 24 will update a timing slack report, which includes the delay time of each of the components, the required time Rs, the arrival time As and the timing slack TS, corresponding to the updated netlist in accordance with the updated netlist. The logic designer can therefore input a set of specific display instructions to enable the second interface 26 to display the timing slack report window 38, to read on the timing slack report window 38 an updated timing slack report corresponding to the updated netlist. The logic designer can also update circuit component information shown in the timing slack report window 38 through the use of the first interface 22 to reduce the slack time TS by equivalently inserting an approximate component between two pieces of data path information, CGEN_A_PST/I_{—}62/Y(NAND2x1) and CGEN_A_PST/I_{—}23/Y(BUFx4) respectively corresponding to two delay times (0.18) and (0.07). Accordingly, the logic unit 24 will update the remaining information of the core database according to the updated circuit component information, and the logic designer can input certain display instructions to enable the second interface 26 to display the netlist window 34 or the physical circuit window 36, and can read the updated netlist shown on the netlist window 34 or execute the placement & routing process on the physical circuit shown on the physical circuit window 36.

In general, the timing slack report that the logic unit 24 generates in accordance with the execution on the placement & routing process, the clock tree synthesis report and the timing optimization report comprises much information. In order to accelerate the update to the timing slack report, the logic unit 24 of the system 20 further has a capacity to classify the timing slack report according to the contents of the timing slack report and divide a large timing slack report into a plurality of small timing slack reports. Therefore, more than one logic designer can cooperate to update the plurality of small timing slack reports at the same time. The logic unit 24 can classify the timing slack report by referring to the circuit components of the timing slack report or to the clock that the timing slack report corresponds.

According to the preferred embodiment, the logic unit 24 not only has the capability to calculate the noise analysis report, power analysis report and timing slack report corresponding to an updated netlist, the logic unit 24 is also capable of referring the updated circuit component information shown on any window and of updating the information shown on the remaining windows. As described previously, the logic designers can update the circuit component information of the timing slack information shown on the timing slack window 36, and at the same time the logic unit 24 will update the netlist and the physical circuit according to the updating process on the circuit component information of the timing slack information, the updated netlist and physical circuit will be shown on the netlist window 34 and the physical circuit window 36 respectively. Moreover, since the circuit is updated, the logic unit 24 will further update the information shown on the remaining windows, such as the timing slack report, the power analysis report and the noise analysis report, etc. In conclusion, the logic designers of the system 20 can select any window and execute the updating process on the circuit shown on the selected window, and the logic unit 24 of the system 20 will accordingly update the information shown on the remaining windows according to the updating process.

In general, since the IC chip 10 can consist of up to millions or tens of million elementary cells 14, the system 20 does not display all the elementary cells 14 on the display panel 26 in great detail. Instead, the system 20 displays on the display panel 26 only those elementary cells 14 and the interconnects 18 connecting the displayed elementary cells 14 which are corresponding to a netlist or a timing slack Sₛ according to the display instructions input to the first interface 22, for example clicking the mouse 22 to select the netlist shown on the netlist window 34.

For instance, when a logic designer selects a circuit description instruction in a netlist set consisting of a plurality of netlist instructions shown on the netlist window 34, a elementary cell 14 in a physical circuit consisting of a plurality of elementary cells shown on the physical circuit window 36, or circuit component information corresponding to a timing slack Sₛ in a timing slack report consisting of a plurality of timing slack Sₛs shown on the timing slack window 36 with the use of the mouse 22 by generating a corresponding display instruction, the system 20 will control the display panel 26 to highlight the circuit description instruction, the elementary cell 14, or the elementary cells 14 and the corresponding interconnects 18 of the IC chip 10 corresponding to the circuit component information corresponding to the timing slack Sₛ of the timing slack information according to the display instruction. In addition, the system 20 is capable of controlling the display panel 26 to display a plurality of spare cells 28 neighboring the highlighted elementary cells 14, the spare cells 28 being the elementary cells 14 not yet utilized by the system 20. Therefore, the logic designers can take a reference of the elementary cells, the interconnects 18 and the spare cells 20 and update the netlist to amend any design errors hid in the timing slack information corresponding to the ASIC 50.

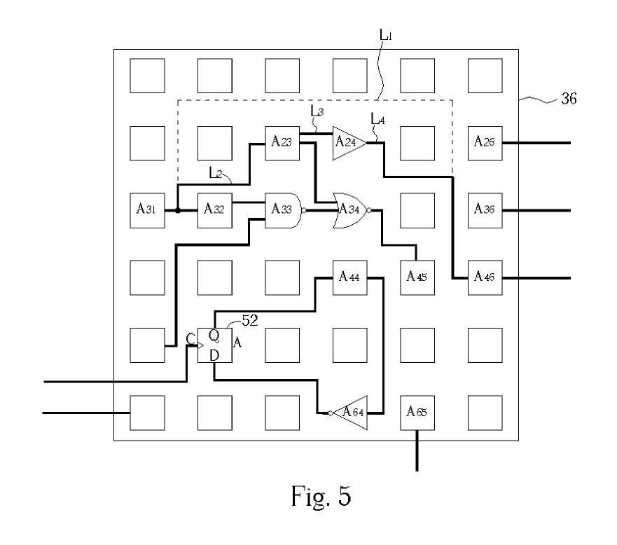

Please refer to FIG. 5, which is an enlarged view of a plurality of elementary cells 14 encircled within a dotted line shown in FIG. 3 on the physical circuit window 36. As described previously, as the logic designers click the mouse 22 to generate a display instruction by selecting the circuit component information corresponding to a timing slack generate a display instruction to Sₛ of the timing slack information, the system 20 will display on the display panel 18 the elementary cells 14 and the interconnects 18 connected between the elementary cells 14, which are corresponding to the circuit component information. As shown in FIG. 5, the circuit component information corresponding to the negative timing slack Sₛ that the logic designers have selected are corresponding to the elementary cell A₃₁ and the elementary cell A₄₆, which is electrically connected to the elementary cell A₃₁ through the interconnect L₁. The signal S to be transferred from the elementary cell A₄₆ to the input/output unit 60 is not stabilized yet. According to the preferred embodiment, in addition to the elementary cell A₃₁, the interconnect L₁, which is shown in FIG. 5 in the form of a dotted line, and the elementary cell A₄₆ the display panel 26 is capable of further displaying the spare cells 28 such as the spare cell A₂₄, which is disposed neighboring the elementary cell A₃₁ as well as the elementary cell A₄₆, according to the display instructions, so that the logic designers are therefore able to execute on the physical circuit window 36 the updating process to reconnect the elementary cell A₃₁ to the elementary cell A₄₆ through a new path consisting of an interconnect L₂, an elementary cell A₂₃, an interconnect L₃, an elementary cell A₂₄, and an interconnect L₄, to transform the negative timing slack Sₛ into a positive timing slack Sₛ and to guarantee that the ASIC 50 can operate normally. Of course, after the logic designers have updated the physical circuit, the core database will be updated accordingly, and the netlist, the timing slack report, the noise analysis report and the power analysis report will be updated too.

In order to increase the readability of the system 20 further, the display panel 26 is capable of selectively displaying a variety of icons, each of the icons corresponding to a elementary cell 14 of the ASIC 50 and having a predetermined pattern corresponding to a predetermined function that the elementary cell 14 plays in the ASIC 50. For example, as shown in FIG. 5 three elementary cells A₅₂, A₆₄, and A₅₂ having latching, inverting, and buffering functions respectively are shown to have a latch, an inverter, and a buffer pattern on the physical circuit window 36 of the display panel 26.

In contrast to the prior art, the present invention can provide an integrated circuit design system capable of displaying all the information of the core database corresponding to the ASIC 50. Therefore, a logic designer can refer to the timing slack report or the function verification report and not only update the netlist, the logic designer can also acquire a variety of information relating to the ASIC 50, such as the placement & routing information and the updated netlist, so as to reduce the time to update the netlist and to increase the efficiency of designing the ASIC 50.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

1. An integrated circuit design system comprising:
a second interface for displaying a plurality of description instructions corresponding to an application-specific integrated circuit (ASIC) according to a variety of display instructions;
a first interface for inputting the display instructions and for updating the description instructions displayed on the second interface according to the display instructions; and
a logic unit for updating any description instruction but an updated description updated by the first interface corresponding to the ASIC according to the updated description instruction.

2. The integrated circuit design system of claim 1, wherein the plurality of description instructions comprises a timing slack report of the ASIC.

3. The integrated circuit design system of claim 1, wherein the plurality of description instructions comprises a netlist of the ASIC.

4. The integrated circuit design system of claim 1, wherein the plurality of description instructions comprises a noise analysis report of the ASIC.

5. The integrated circuit design system of claim 1, wherein the plurality of description instructions comprises a power analysis report of the ASIC.

6. The integrated circuit design system of claim 3, wherein the logic unit is further capable of calculating a noise analysis report corresponding to an undated netlist.

7. The integrated circuit design system of claim 3, wherein the logic unit is further capable of calculating a power analysis report corresponding to an undated netlist.

8. The integrated circuit design system of claim 3, wherein the logic unit is further capable of calculating a timing slack report corresponding to an undated netlist.

9. The integrated circuit design system of claim 1, wherein the logic unit is further capable of executing a clock tree synthesis.

10. The integrated circuit design system of claim 1, wherein the logic unit is further capable of executing a timing optimization process.

11. The integrated circuit design system of claim 1, wherein the logic unit is further capable of executing a cell & wire extraction process and for generating a cell & wire delay of a standard delay format (SDF).

12. The integrated circuit design system of claim 1, wherein the second interface is capable of displaying cells and interconnects connected between the cells of the ASIC according to a specified display instruction input to the first interface.

13. The integrated circuit design system of claim 12, wherein the second interface is capable of further displaying spare cells neighboring the cells according to the specified display instruction.

14. The integrated circuit design system of claim 12, wherein the second interface is capable of displaying a plurality of specified icons, each of the icons corresponding to a specified cell having a specified function corresponding to the specified icon.

15. The integrated circuit design system of claim 2, wherein the logic unit is further capable of dividing the timing slack report into a plurality of timing slack sub-reports, each of the timing slack sub-reports having less information than that of the timing slack report.

16. The integrated circuit design system of claim 15, wherein the logic unit divides the timing slack report into the timing slack sub-reports according to circuit components referenced by the timing slack report.

17. The integrated circuit design system of claim 15, wherein the logic unit divides the timing slack report into the timing slack sub-reports according to clocks referenced by the timing slack report.
